(19) United States
(12) Patent Application Publication
(10) Pub. No.: US 2008/0052389 A1
(43) Pub. Date: Feb. 28, 2008

(54) METHOD AND APPARATUS FOR INFERRING THE BUSY STATE OF AN INSTANT MESSAGING USER

(76) Inventors: David A. George, Somers, NY (US); Raymond B. Jennings, Ossining, NY (US)

Correspondence Address: HOFFMAN, WARNICK & D'ALESSANDRO LLC, 75 State Street, 14th Floor, ALBANY, NY, 12207, US

(21) Appl. No.: 11/466,781

(22) Filed: Aug. 24, 2006

(51) Int. Cl. G06F 15/16; G06F 15/173

(52) U.S. Cl. 709/224; 379/88.17; 709/207

(57) ABSTRACT

The present invention provides a method and apparatus for inferring the busy state of an instant messaging (IM) user. A method for inferring the busy state of an IM user in accordance with an embodiment of the present invention includes: obtaining a plurality of messages from a system of the IM user, wherein the system messages are indicative of a level of activity of the IM user; analyzing the system messages to infer a busy state of the IM user; and providing the busy state of the IM user to at least one other IM user.

### FIELD OF THE INVENTION

The present invention generally relates to instant messaging, and more specifically relates to a method and apparatus for inferring the busy state of an instant messaging user.

### BACKGROUND OF THE INVENTION

Many instant messaging (IM) programs have a presence indicator to show the status of an IM user. Typical presence indicators can include, for example, “active,” “available,” “away,” “off-line,” and “busy.” In addition, many IM programs allow a user to manually set an away message, such as “busy,” “on the phone,” and “stepped away.”

Existing presence indicators are only accurate at a coarse level and can frequently be incorrect. For example, although an IM user's presence indicator may be listed as “active,” the IM user may be involved in many CPU related tasks (e.g., typing, reading email, editing photos, etc.) and may not want to receive non-urgent instant messages from other IM users. To this extent, existing presence indicators do not provide an indication of how busy an IM user actually is at any given time. Thus, there is a need for a method and apparatus for inferring the busy state of an instant messaging user.

### SUMMARY OF THE INVENTION

The present invention relates to a method and apparatus for inferring the busy state of an IM user. In accordance with an embodiment of the present invention, an IM program infers how busy an IM user is by using various system messages from the user's system including, for example, messages from the underlying operating system, applications, hardware, networks, and user input devices (e.g., keyboard or mouse). Such system messages are indicative of a level of activity of the IM user. The busy state of the IM user is sent to the IM server. When an IM user desires to send an instant message to another IM user, the IM user can check the “busyness” status of the other IM user to determine if they should or should not send the instant message.

A first aspect of the present invention is directed to a method for inferring a busy state of an instant messaging user, comprising: obtaining a plurality of messages from a system of the IM user, wherein the system messages are indicative of a level of activity of the IM user; analyzing the system messages to infer a busy state of the IM user; and providing the busy state of the IM user to at least one other IM user.

A second aspect of the present invention is directed to a system for inferring a busy state of an instant messaging user, comprising: a system for obtaining a plurality of messages from a system of the IM user, wherein the system messages are indicative of a level of activity of the IM user; a system for analyzing the system messages to infer a busy state of the IM user; and a system for providing the busy state of the IM user to at least one other IM user.

A third aspect of the present invention is directed to a program product stored on a computer readable medium for inferring a busy state of an instant messaging user, the computer readable medium comprising program code for: obtaining a plurality of messages from a system of the IM user, wherein the system messages are indicative of a level of activity of the IM user; analyzing the system messages to infer a busy state of the IM user; and providing the busy state of the IM user to at least one other IM user.

A fourth aspect of the present invention is directed to a method for deploying an application for inferring a busy state of an instant messaging user, comprising: providing a computer infrastructure being operable to: obtain a plurality of messages from a system of the IM user, wherein the system messages are indicative of a level of activity of the IM user; analyze the system messages to infer a busy state of the IM user; and provide the busy state of the IM user to at least one other IM user.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts an illustrative computer network including an IM server and a plurality of IM clients.

FIG. 2 depicts a flow diagram of an illustrative process for inferring the busy state of an IM user in accordance with an embodiment of the present invention.

FIG. 3 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention relates to a method and apparatus for inferring the busy state of an IM user. In accordance with an embodiment of the present invention, an IM program infers how busy an IM user is by using various system messages from the user's system including, for example, messages from the underlying operating system, applications, hardware, networks, and user input devices (e.g., keyboard or mouse). Such system messages are indicative of a level of activity of the IM user. The busy state of the IM user is sent to the IM server. When an IM user desires to send an instant message to another IM user, the IM user can check the “busyness” status of the other IM user to determine if they should or should not send the instant message. Thus, a potential sender of an instant message is provided with an indicator of how busy each potential receiver of the instant message currently is without any explicit response from, or manual intervention by, the potential receivers of the instant message.

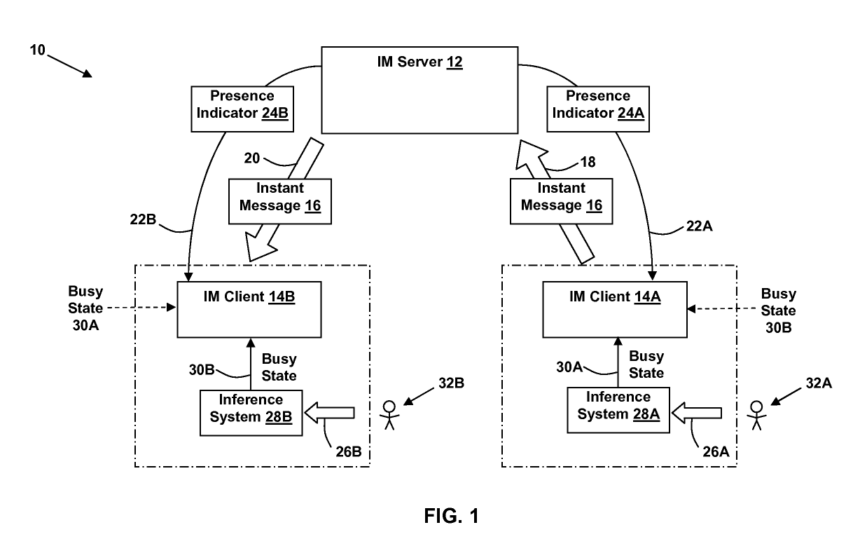

FIG. 1 depicts an illustrative computer network 10 including an IM server 12 and a plurality of IM clients 14A, 14B (only two IM clients are shown for clarity of illustration/description). Each of the IM clients 14A, 14B is provided on a computer system, PDA, cell-phone, or other suitable device (as indicated in phantom) and is connected to the IM server 12. The IM clients 14A, 14B can be connected to the IM server 12 over a physical computer network, a wireless network such as those used by cell phones and personal digital assistants (PDAs), and/or in any other now known or later developed manner.

To send an instant message 16 to IM client 14B, the IM client 14A first sends 18 the instant message 16 to the IM server 12. The IM server 12 then forwards 20 the instant message 16 to the IM client 14B. Alternatively, in the case of a direct connection IM system, the instant message 16 would flow directly from the IM client 14A to the IM client 14B.

When the IM client 14A becomes active to the IM server 12, the IM client 14A receives 22A a presence indicator 24A from the IM server 12 regarding each other IM client that IM client 14A has subscribed to (e.g., the IM clients on a “buddy” list). A similar process occurs with respect to the IM client 14B, in which the IM client 14B receives 22B a presence indicator 24B from the IM server 12 regarding each other IM client to which the IM client 14B has subscribed.

Typical windows-based operating systems (For example those provided by Microsoft, Apple and the various versions of UNIX) use a windows manager to manage the windows of applications that are running simultaneously. The applications take input from the underlying operating system and operating system windows manager regarding how to manage what each application window displays. Some of the messages sent to a windows type application by the windows manager include, for example, that a window is going out of view, either partially or completely, that part or all of a window has come back into view, or that a window is about to become minimized or maximized. These messages are used by the individual applications so that the window can either update its contents if it is now in view or stop updating the window if it is not in view. In addition, a windows application can typically register with the windows manager to receive system messages about any user input from a keyboard or mouse or about other services running on the operating system.

In accordance with the present invention, such system messages 26A, 26B from the underlying operating system, applications, hardware, network, and user input devices (e.g., keyboard or mouse), are used by an inference system 28A, 28B to infer a busy state 30A, 30B of an IM user 32A, 32B of a respective IM client 14A, 14B. For example, the busy state 30B of the IM user 32B is provided to the IM server 12 and is subsequently provided to the IM client 14A. Similarly, the busy state 30A of the IM user 32A is provided to the IM server 12 and is subsequently provided to the IM client 14B. The busy states 30A, 30B are forwarded to the IM server 12 (e.g., by the IM client 14A, 14B or the inference system 28A, 28B) and subsequently provided to the IM clients 14B, 14A, respectively, as indicated in phantom. The IM server 12 can provide the busy states 30A, 30B via the presence indicators 24B, 24A, respectively, or in any other suitable manner. It should be noted that in a direct connection IM system, the above process would occur sans the IM server 12.

The busy states 30A, 30B provide a rating of how busy an IM user 32A, 32B is at any given time. For example, the busy states 30A, 30B of an IM user 32A, 32B can provide a rating in the range of “Free” to “Extremely Busy,” or in the range of “1” to “100,” where “1” indicates that an IM user 32A, 32B is not busy at all and can receive an instant message and “100” indicates that an IM user 32A, 32B is extremely busy and cannot be bothered with incoming instant messages. The rating can also be as simple as “No IM” or “0” and “Okay to IM” or “1.” Any suitable rating methodology that can indicate the busyness of an IM user 32A, 32B can be used in the practice of the present invention. In general, the busy states 30A, 30B are not intended to provide an exact measurement, but only a rough indication of the busyness of an IM user 32A, 32B.

The busyness of an IM user 32A, 32B can be indicated using any suitable type of indicia, including alphanumeric and numeric indicia as described above. Alternatively and/or in addition, color, images, sound, animation, and the like can also be used to indicate the busyness of an IM user 32A, 32B.

An IM user 32A, 32B can also manually set/adjust the busy state 30A, 30B of his/her own IM client 14A, 14B. This can be done, for example, via the Preferences settings, a menu selection, a keyboard shortcut, etc., in the IM client 14A, 14B. An administrator can also manually set/adjust the busy state of an IM user 32A, 32B at the IM server 12. The inference system 28A, 28B can be configured to take into account previous manual adjustments of the busy state 30A, 30B by an IM user 32A, 32B to allow the inferring process to learn from past inputs.

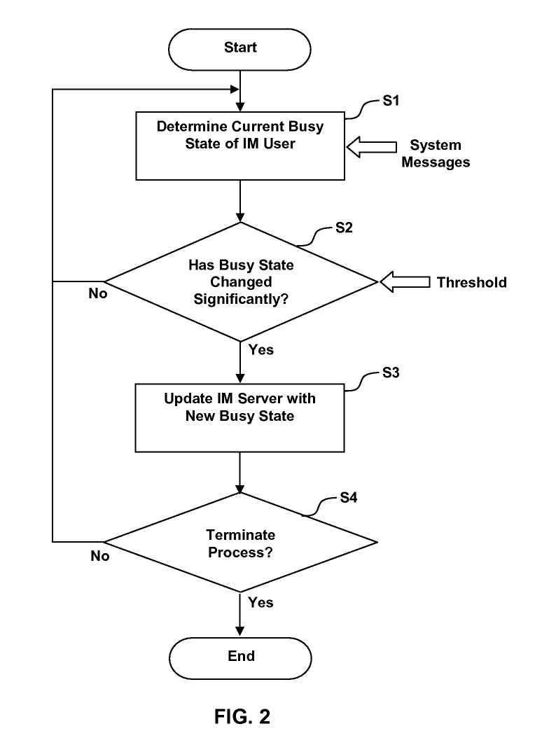

FIG. 2 depicts a flow diagram of an illustrative process for inferring the busy state of an IM user in accordance with an embodiment of the present invention. At step S1, the system messages are obtained and analyzed to determine the busy state of an IM user. At step S2, a determination is made whether the current busy state has changed significantly since the last determination at step S1. If the busy state of the IM user has changed more than a predefined threshold amount, then the IM server is updated by the IM client at step S3 with the current busy state. If not, flow passes back to step S1. The process is then repeated periodically (e.g., once per minute, once every 10 minutes, etc.) or randomly until it is determined in step S4 that the IM user has quit the IM client or has terminated the process in some manner (e.g., via the Preferences settings, a menu selection, a keyboard shortcut, etc., in the IM client). The IM server can cause the process to terminate as well. The predefined threshold amount can be also configured via the Preferences settings, a menu selection, a keyboard shortcut, etc., in the IM client, by the IM server, or in any other suitable manner.

Examples of the types of information that can be used to determine the current busy state of an IM user can include:

(A) The number of times application windows have changed state (e.g., the number of times application windows have been moved, minimized or maximized, and covered or uncovered) within a specified time period (e.g., every minute, every ten minutes, etc.). A large number of windows movement system messages could mean that the user is heavily engaged in several different applications at the same time. The time period can be predefined, user-defined, or set in any suitable manner, and can be adjusted, if/as necessary.
(B) The number of mouse operations (e.g., mouse movements, mouse button actuations, etc.), keystrokes, and other input device usage within a specified time period (e.g., every minute, every ten minutes, etc.). A large number of mouse movement or keystroke related system messages could also mean that the user is heavily engaged in several different applications at the same time. The time period can be predefined, user-defined, or set in any suitable manner, and can be adjusted, if/as necessary. The usage of other types of input devices, including, for example, track-pads, track-balls, track-sticks, digital pens, digital tablets, buttons, touch-sensitive screens, joysticks, microphones, arrow navigation buttons, etc., can also be analyzed to infer the busy state of an IM user.

### (C) Traditional system attributes such as CPU utilization, network traffic (e.g., number of bytes sent, number of bytes received), memory usage, etc.

(D) The number of email messages, instant messages or voice over IP (VoIP) phone calls received/sent within a specified time period. In addition, the number of currently unread email and instant messages or the number of unheard phone messages could be used. The time period can be predefined, user-defined, or set in any suitable manner, and can be adjusted, if/as necessary.
(E) The state of a screen saver or sleep mode. For instance, the busy state can be set to a value indicating that a user is available to receive an instant message if a screen saver is active or if the computer on which the IM client is running is in a sleep mode.

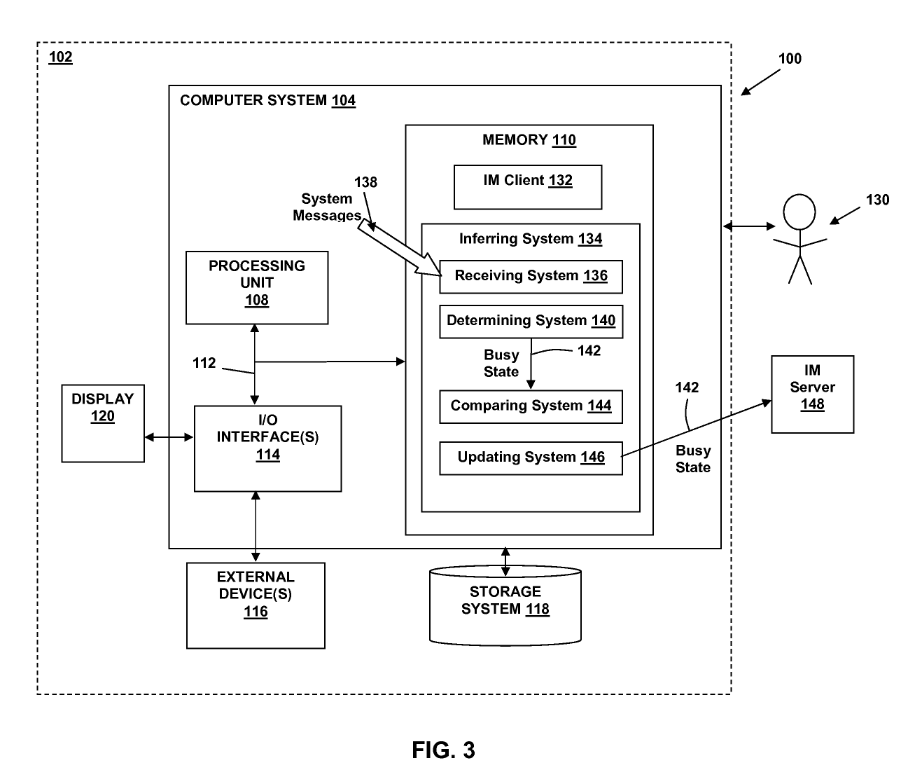

FIG. 3 depicts an illustrative system 100 for inferring the busy state of an IM user 130 in accordance with embodiment(s) of the present invention. The system 100 includes a computer infrastructure 102 that can perform the various process steps described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as IM client 132 and inferring system 134, that are stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user 130 to interact with the computer system 104 or any device that enables the computer system 104 to communicate with one or more other computer systems.

In accordance with an embodiment of the present invention, the inferring system 134 includes a receiving system 136 for receiving system messages 138 from at least the computer system 104, a determining system 140 for determining the busy state 142 of the IM user 130 based on the system messages 138, a comparing system 144 for determining if the busy state 142 of the IM user 130 has changed significantly since last determined, and a updating system 146 for providing an IM server 148, if necessary, with an updated busy state 142. The operation(s) carried out by each of these systems is described in greater detail above.

The computer system 104 can comprise any general purpose computing article of manufacture capable of executing computer program code installed by a user (e.g., a personal computer, server, handheld device, etc.). However, it is understood that the computer system 104 is only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 3 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in one embodiment, the invention provides a computer-readable medium that includes computer program code to enable a computer infrastructure to carry out and/or implement the various process steps of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. A service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. The program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for inferring a busy state of an instant messaging (IM) user, comprising:
obtaining a plurality of messages from a system of the IM user, wherein the system messages are indicative of a level of activity of the IM user;
analyzing the system messages to infer a busy state of the IM user; and
providing the busy state of the IM user to at least one other IM user.

2. The method of claim 1, wherein analyzing the system messages provides an indication of a number of times at least one application window changes state within a time period.

3. The method of claim 2, wherein the change in state comprises at least one of:
a movement of an application window;
a change in size of an application window; and
a covering or uncovering of an application window.

4. The method of claim 1, wherein analyzing the system messages provides an indication of an amount of input device usage.

5. The method of claim 4, wherein the amount of input device usage comprises at least one of:
a number of mouse operations; and
a number of keystrokes.

6. The method of claim 1, wherein the system messages provide system attributes.

7. The method of claim 6, wherein the system attributes comprise at least one of:
CPU utilization;
network traffic; and
memory usage.

8. The method of claim 1, wherein analyzing the system messages provides an indication of least one of:
a number of email messages received or sent during a time period;
a number of instant messages received or sent during a time period;
a number of phone calls received or sent during a time period;
a number of unread email messages;
a number of unread instant messages; and
a number of unanswered phone messages.

9. The method of claim 1, wherein analyzing the system messages provides an indication of a state of at least one of:
a screen saver; and
a sleep mode.

10. The method of claim 1, wherein providing the busy state of the IM user to at least one other IM user further comprises:
providing the busy state using a presence indicator.

11. A system for inferring a busy state of an instant messaging (IM) user, comprising:
a system for obtaining a plurality of messages from a system of the IM user, wherein the system messages are indicative of a level of activity of the IM user;
a system for analyzing the system messages to infer a busy state of the IM user; and
a system for providing the busy state of the IM user to at least one other IM user.

12. The system of claim 11, wherein the system for analyzing the system messages provides an indication of a number of times at least one application window changes state within a time period.

13. The system of claim 12, wherein the change in state comprises at least one of:
a movement of an application window;
a change in size of an application window; and
a covering or uncovering of an application window.

14. The system of claim 11, wherein the system for analyzing the system messages provides an indication of an amount of input device usage.

15. The system of claim 14, wherein the amount of input device usage comprises at least one of:
a number of mouse operations; and
a number of keystrokes.

16. The system of claim 11, wherein the system messages provide system attributes.

17. The system of claim 16, wherein the system attributes comprise at least one of:
CPU utilization;
network traffic; and
memory usage.

18. The system of claim 11, wherein the system for analyzing the system messages provides an indication of at least one of:
a number of email messages received or sent during a time period;
a number of instant messages received or sent during a time period;
a number of phone calls received or sent during a time period;
a number of unread email messages;
a number of unread instant messages; and
a number of unanswered phone messages.

19. The system of claim 11, wherein the system for analyzing the system messages provides an indication of a state of at least one of:
a screen saver; and
a sleep mode.

20. The system of claim 11, wherein the system for providing the busy state of the IM user to at least one other IM user further comprises:
a system for providing the busy state using a presence indicator.

21. A program product stored on a computer readable medium for inferring a busy state of an instant messaging (IM) user, the computer readable medium comprising program code for:
obtaining a plurality of messages from a system of the IM user, wherein the system messages are indicative of a level of activity of the IM user;
analyzing the system messages to infer a busy state of the IM user; and
providing the busy state of the IM user to at least one other IM user.
